(19) United States
(12) Patent Application Publication
(10) Pub. No.: US 2021/0166080 A1
(43) Pub. Date: Jun. 3, 2021

(54) UTILIZING OBJECT ORIENTED PROGRAMMING TO VALIDATE MACHINE LEARNING CLASSIFIERS AND WORD EMBEDDINGS

(71) Applicant: Accenture Global Solutions Limited, Dublin (IE)

(72) Inventors: Sanjay PODDER, Thane (IN); Neville DUBASH, Mumbai (IN); Nisha RAMACHANDRA, Bangalore (IN); Raghotham M. RAO, Bangalore (IN); Manish AHUJA, Bengaluru (IN); Samarth SIKAND, Jaipur (IN)

(21) Appl. No.: 17/108,438

(22) Filed: Dec. 1, 2020

Related U.S. Application Data
(60) Provisional application No. 62/942,538, filed on Dec. 2, 2019.

(51) Int. Cl. G06K 9/62; G06N 20/00; G06T 7/90

(52) U.S. Cl. CPC G06K 9/6262; G06N 20/00; G06T 2207/20081; G06T 2207/10024; G06T 7/90

(57) ABSTRACT

In some implementations, a device may receive a machine learning model to be tested. The device may process the machine learning model, with generalization testing methods, to determine generalization which identifies responsiveness of the machine learning model to varying inputs. The device may process the machine learning model, with robustness testing methods, to determine robustness which identifies responsiveness of the machine learning model to improper inputs. The device may process the machine learning model, with an interpretability testing method, to determine decisions of the machine learning model. The device may calculate a score for the machine learning model based on the generalization data, the robustness data, and the interpretability data. The device may perform one or more actions based on the score for the machine learning model.

### CROSS-REFERENCE TO RELATED APPLICATION

This Patent Application claims priority to U.S. Provisional Patent Application No. 62/942,538, filed on Dec. 2, 2019, and titled “UTILIZING OBJECT ORIENTED PROGRAMMING TESTING MODELS TO VALIDATE AN ARTIFICIAL INTELLIGENCE MODEL.” The disclosure of the prior Application is considered part of and is incorporated by reference into this Patent Application.

### BACKGROUND

A machine learning model is built based on sample data, known as training data, in order to make predictions or decisions without being explicitly programmed to do so. Machine learning models are used in a wide variety of applications, such as email filtering and computer vision, where it is difficult or infeasible to develop conventional models to perform needed tasks.

### SUMMARY

In some implementations, a method includes receiving, by a device, a machine learning model to be tested; processing, by the device, the machine learning model, with generalization testing methods, to determine generalization data identifying responsiveness of the machine learning model to varying inputs; processing, by the device, the machine learning model, with robustness testing methods, to determine robustness data identifying responsiveness of the machine learning model to improper inputs; processing, by the device, the machine learning model, with an interpretability testing methods, to determine interpretability data identifying decisions of the machine learning model; calculating, by the device, a score for the machine learning model based on the generalization data, the robustness data, and the interpretability data; and performing, by the device, one or more actions based on the score for the machine learning model.

In some implementations, a device includes one or more memories and one or more processors, communicatively coupled to the one or more memories, configured to: access a machine learning model to be tested; process the machine learning model, with generalization testing methods, to determine generalization data identifying responsiveness of the machine learning model to varying inputs; process the machine learning model, with robustness testing methods, to determine robustness data identifying responsiveness of the machine learning model to improper inputs; process the machine learning model, with an interpretability testing methods, to determine interpretability data identifying decisions of the machine learning model; calculate a score for the machine learning model based on the generalization data, the robustness data, and the interpretability data; generate additional test inputs for the machine learning model based on the score; and implement the additional test inputs for testing the machine learning model.

In some implementations, a non-transitory computer-readable medium storing a set of instructions includes one or more instructions that, when executed by one or more processors of a device, cause the device to: receive a machine learning model to be tested, wherein the machine learning model includes an image classifier model, a word embedding model, or any machine learning based classifier model in general; process the machine learning model, with generalization testing methods, to determine generalization data identifying responsiveness of the machine learning model to varying inputs; process the machine learning model, with robustness testing methods, to determine robustness data identifying responsiveness of the machine learning model to improper inputs; process the machine learning model, with an interpretability testing methods, to determine interpretability data identifying decisions of the machine learning model; calculate a score for the machine learning model based on the generalization data, the robustness data, and the interpretability data; and perform one or more actions based on the score for the machine learning model.

### BRIEF DESCRIPTION OF THE DRAWINGS

FIGS. 1A-1F are diagrams of an example implementation described herein.

FIG. 2 is a diagram of an example environment in which systems and/or methods described herein may be implemented.

FIG. 3 is a diagram of example components of one or more devices of FIG. 2.

FIG. 4 is a flowchart of an example process for utilizing object oriented programming testing methods to validate a machine learning model.

### DETAILED DESCRIPTION

The following detailed description of example implementations refers to the accompanying drawings. The same reference numbers in different drawings may identify the same or similar elements.

Currently, machine learning models have been successful in numerous applications. However, machine learning models may experience unanticipated failures in certain applications. A fundamental reason for such failures is that a machine learning model is inherently difficult to test due to an extremely large input space and unexpected results, and difficulty in creating test cases to evaluate the machine learning model. The common approach to testing a machine learning model is to first have the input data split into a training data set and a test data set (e.g., 80% of the input data is included in the training data set and 20% of the input data is included in the test data set). The training data set is used to train the machine learning model. Then, the test data set is used to evaluate the performance of the machine learning model. However, the test data set only covers a small fraction of the input space, leaving many corner cases, for example, untested. This, in turn, wastes computing resources (e.g., processing resources, memory resources, communication resources, and/or the like), networking resources, human resources, and/or the like associated with implementing an insufficiently tested machine learning model, identifying errors generated by the untested machine learning model, correcting the untested machine learning model to prevent the errors, and/or the like. Additionally, most existing techniques for identifying an incorrect behavior of a machine learning model require human effort to manually label samples with correct output, which quickly becomes prohibitively expensive for large datasets.

Further, the machine learning model may not be evaluated on three aspects: generalization, robustness, and interpretability. Generalization may measure the ability of the model to perform well on new inputs not seen during its training. Robustness may measure the ability of the model to be not susceptible to maliciously crafted inputs to specifically fool the model. Interpretability may provide information that can be used to interpret the decision making process of the model.

Some implementations described herein relate to a testing system that utilizes object oriented programming (OOP) testing methods to validate a machine learning model. For example, the testing system may receive a machine learning model to be tested. The testing system may process the machine learning model, with generalization testing methods, to determine generalization data identifying responsiveness of the machine learning model to varying inputs. The generalization data may indicate an ability of the machine learning model to perform well on new inputs not seen during model training.

The testing system may process the machine learning model, with robustness testing methods, to determine robustness data identifying responsiveness of the machine learning model to improper inputs. The robustness data may indicate an ability of the machine learning model to not be susceptible to malicious inputs designed to specifically fool the machine learning model.

The testing system may process the machine learning model, with an interpretability testing methods, to determine interpretability data identifying decisions of the machine learning model. The interpretability data may include information associated with interpreting decisions of the machine learning model, and/or information exposing features of an input recognized by the machine learning model while identifying the input as an input recognized by the machine learning model.

The testing system may calculate a score for the machine learning model based on the generalization data, the robustness data, and the interpretability data. The testing system may validate the machine learning model based on the score. In this way, the testing system utilizes OOP testing methods to validate a machine learning model. The testing system interprets decisions of the machine learning model in a guided way to build trustworthiness in the machine learning model. The OOP testing methods tests functionality of the machine learning model based on characteristics of the machine learning model, such as generalization, robustness, interpretability, and/or the like. This, in turn, conserves computing resources, networking resources, human resources, and/or the like that would otherwise have been wasted in implementing an untested machine learning model, identifying errors generated by the untested machine learning model, correcting the untested machine learning model to prevent the errors, and/or the like.

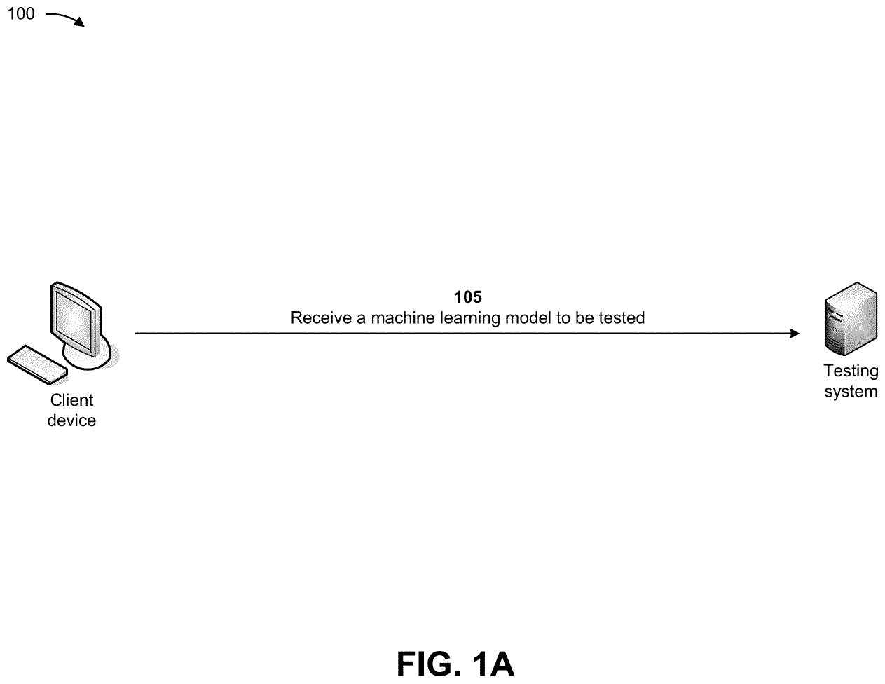

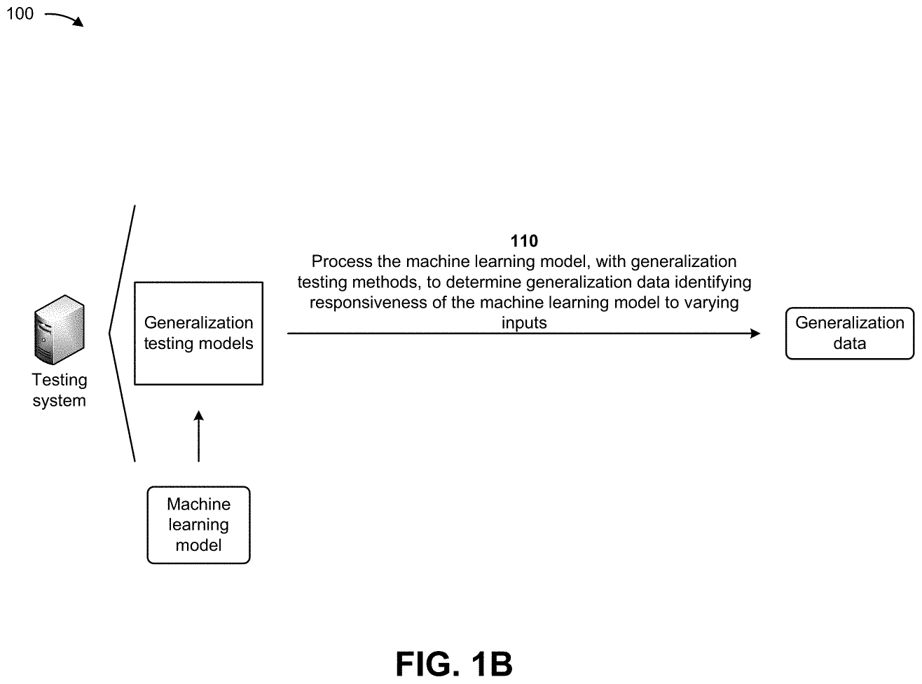

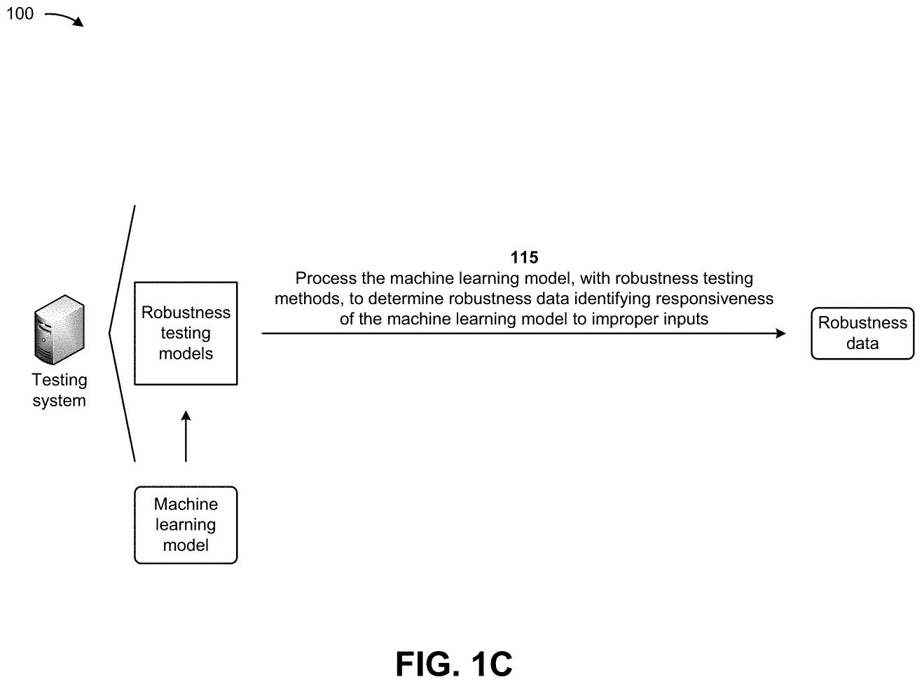

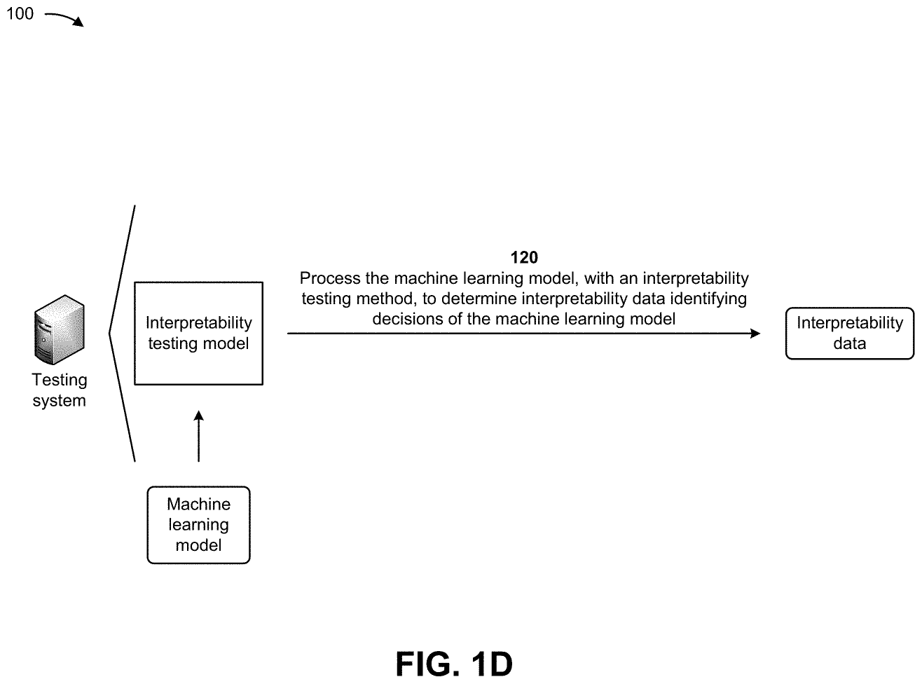

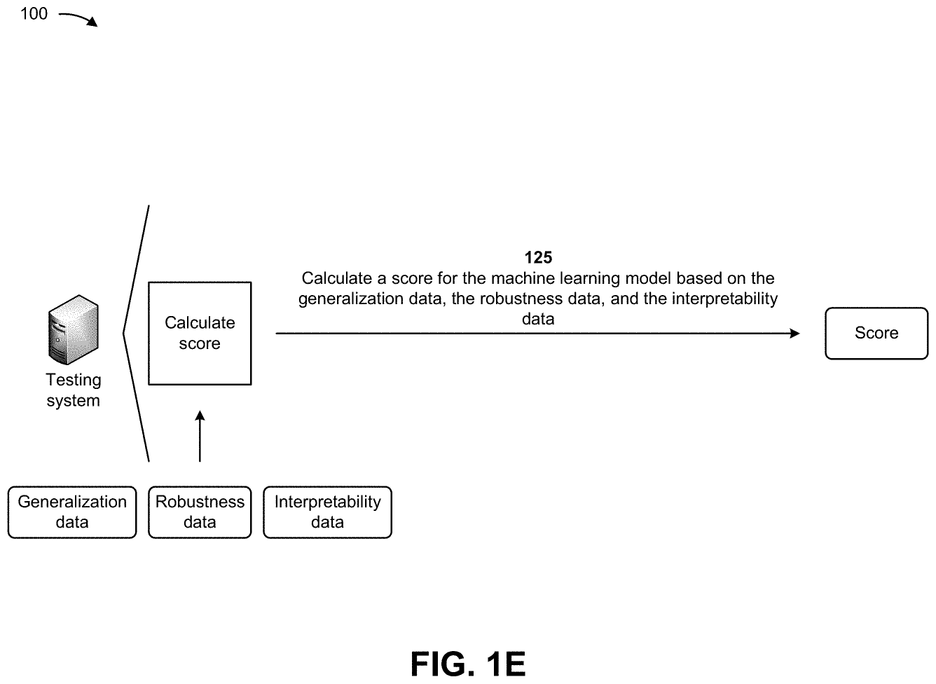

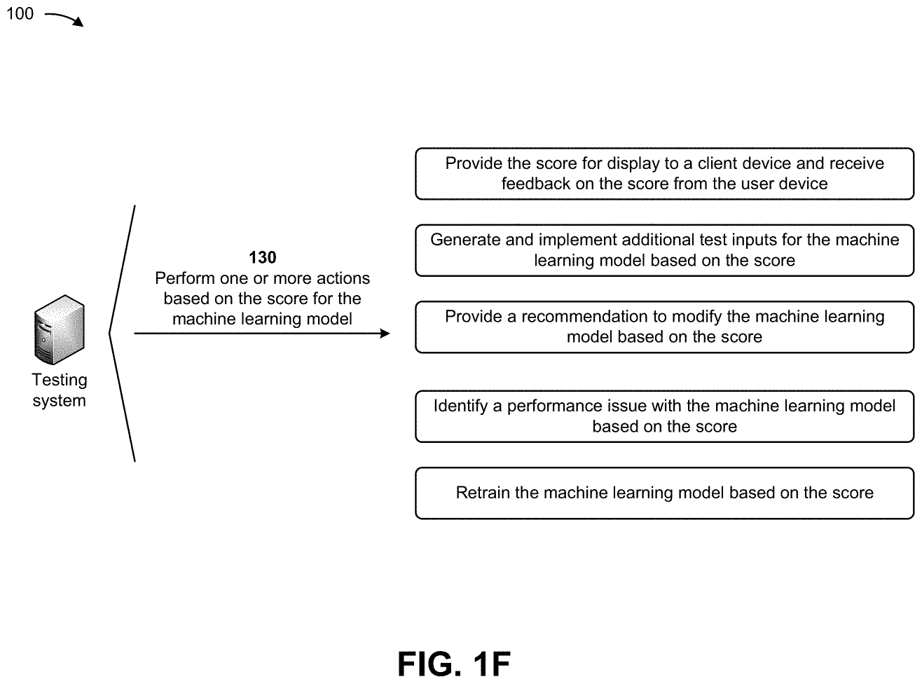

FIGS. 1A-1F are diagrams of an example 100 associated with utilizing object oriented programming testing models to validate a machine learning model. As shown in FIGS. 1A-1F, example 100 includes a client device associated with a testing system. The client device may include a laptop computer, a mobile telephone, a desktop computer, and/or the like. The testing system may include a system that utilizes OOP testing methods to validate a machine learning model.

As shown in FIG. 1A, and by reference number 105, the testing system receives a machine learning model to be tested. The machine learning model may include an image classifier model, a word embedding model, and/or another type of machine learning model.

In some implementations, the testing system includes a library of different validating techniques (e.g., OOP methods) that facilitate validation of the machine learning model (e.g., of classifier models based on images and/or unstructured data, classifier/predictive models based on structured data, word embedding models based on textual data, and/or the like). The testing system may systematically validate the machine learning model based on generalization, robustness, and interpretability to identify cases of failures as a pre-emptive measure (e.g., since an input space for a machine learning model is large, the testing system may cover as many test cases as possible in order to attempt to identify possible failure cases).

In some implementations, the testing system provides a mechanism to load a state of a machine learning model, performs image sizing and image pre-processing techniques on the machine learning model, trains a quantity of class names for which the machine learning model is trained via index-class mapping, and/or the like. In some implementations, the testing system includes a library (e.g., a python library) that a user of the testing system may utilize to validate a machine learning model and visualize testing output on a user interface for making decisions about limitations of the machine learning model. The library may include different testing models under various characteristics (e.g., generalization, robustness, and/or interpretability) for testing machine learning models, such as image classifier models and word embedding models. The testing results of the different testing models may be provided for display via a user interface associated with the testing system, as described in greater detail below.

As shown in FIG. 1B, and by reference number 110, the testing system processes the machine learning model, with generalization testing models, to determine generalization data identifying responsiveness of the machine learning model to varying inputs. The generalization data may include information indicating an ability of the machine learning model to perform well on new inputs not seen during model training.

In some implementations, the generalization data includes rotation and translation data, Fourier filtering data, grey scale data, contrast data, additive noise data, and/or Eidolon noise data associated with the machine learning model. The rotation and translation data may indicate an ability of the machine learning model to be invariant to rotations and translations of an image. For example, the generalization testing methods may include a rotation and translation method that determines an ability of the machine learning model to be invariant to small rotations (e.g., changes in the orientation) and translations (e.g., shifting of the pixels) of an image.

The Fourier filter data may indicate an ability of the machine learning model to be invariant to information loss. For example, the generalization testing models may include a Fourier filtering method that determines an ability of the machine learning model to be invariant to information loss (e.g., when frequencies with low information content are removed).

The grey scale data may indicate an ability of the machine learning model to be invariant to color content of the image. For example, the generalization testing methods may include a gray scale method that determines whether the machine learning model is invariant to color content of the image.

The contrast data may indicate an ability of the machine learning model to be invariant to a contrast of the image. For example, the generalization testing methods may include a contrast method that determines whether the machine learning model is invariant to contrast of the image.

The additive noise data may indicate an ability of the machine learning model to be invariant to noise in the image. For example, the generalization testing methods may include an additive noise method that determines whether the machine learning model is invariant to low amounts of noise in the image.

The Eidolon noise data may indicate an ability of the machine learning model to be invariant to noise that creates a form deformation. For example, the generalization testing methods may include an Eidolon noise method that determines whether the machine learning model is invariant to noise that creates a form of deformation (e.g., Eidolon) that may be imperceptible to a human observer.

As shown in FIG. 1C, and by reference number 115, the testing system processes the machine learning model, with robustness testing models, to determine robustness data identifying responsiveness of the machine learning model to adversarial (e.g., improper, malicious, and/or the like) inputs. The robustness data may identify an ability of the machine learning model to not be susceptible to adversarial inputs designed to fool the machine learning model. In some implementations, the machine learning model comprises an image classifier model, and the robustness testing models evaluate the machine learning model based on small perturbations that may lead to misclassification of an image.

In some implementations, the robustness data may include fast gradient sign method data, Carlini-Wagner method data, and/or adversarial patch data associated with the machine learning model. For example, the robustness testing methods may include adversarial input methods (e.g., a fast gradient sign model (FGSM) and Carlini-Wagner model) that check the machine learning model based on adversarial inputs (e.g., malicious inputs, such as inputs that may not occur naturally but may be misused by a malicious party); an adversarial patches method that determines an impact on the machine learning model when a specially crafted adversarial patch is introduced (e.g., overlaid on an image); and/or the like.

Alternatively, and/or additionally, the robustness data may include synonym detection data, word analogy data, outlier detection data, and/or clustering data associated with the machine learning model. The machine learning model may comprise a word embedding model and the quality of the word embeddings is determined based on synonym detection, word analogy, outlier detection, and/or clustering performed on the word embedding model.

Since it is believed that the word embeddings encode the meaning and semantics of the word, evaluating embedding models on synonym detection task generally relates to the quality of the embeddings.

The word analogy data may indicate an accuracy of the machine learning model associated with determining a word analogy. The machine learning model may determine a word analogy by predicting a word “d” given three words “a”, “b”, and “c” such that a relationship between “a” and “b” is similar to a relationship between “c” and “d”.

The outlier detection data may indicate an accuracy of the machine learning model associated with performing outlier detection. The machine learning model may perform outlier detection by detecting an outlier word, given a set of words. As an example, given the set of words Monday, Tuesday, Sunday, and Hockey, the machine learning model may detect the word Hockey as an outlier word.

The clustering data may indicate an accuracy of the machine learning model associated with performing clustering. The machine learning model may perform clustering by grouping words associated with a similar concept (e.g., an abstract concept, a concrete concept, and/or the like) in a same cluster.

As shown in FIG. 1D, and by reference number 120, the testing system processes the machine learning model, with an interpretability testing method, to determine interpretability data identifying decisions of the machine learning model. The interpretability testing method may include a local interpretable model-agnostic explanations (LIME) method and/or a similar method that determines and explains decisions of the machine learning model. The interpretability data may identify incorrect features of an input that were used in decisions of the machine learning model.

In some implementations, the testing system may train the interpretability testing methods (e.g., referred to as the models) based on historical data (e.g., historical machine learning models). In some implementations, the testing system may separate the historical data into a training set, a validation set, a test set, and/or the like. The training set may be utilized to train the models. The validation set may be utilized to validate results of the trained models. The test set may be utilized to test operation of the models.

In some implementations, rather than training the models, the testing system may receive trained models from another device. For example, the client device, a third-party server device, and/or the like may generate the models based on having trained the models in a manner similar to that described above, and may provide the trained models to the testing system (e.g., may pre-load the testing system with the models, may provide the trained models based on receiving a request from the testing system for the trained models, and/or the like).

During utilization of the testing system, a user may define a class that abstracts the machine learning model. The class may include specific attributes and function signatures across the models utilized by the testing system; however, implementations of the functions may be different. The machine learning model may be passed to a function (e.g., that triggers testing) of respective models of the testing system. Once the machine learning model class with necessary attributes and functions is defined, the user may define some additional variables, such as a path to the machine learning model, a path to save testing results, and/or the like. The user may then begin validating the machine learning model by instantiating the machine learning model class and passing the machine learning model class, along with necessary variables, to the respective validating methods of the testing system. When the testing results are available, the user may view the testing results via an interactive user interface provided by the testing system to the client device.

As shown in FIG. 1E, and by reference number 125, the testing system calculates a score for the machine learning model based on the generalization data and a score for the machine learning model based on the robustness data. In some implementations, the score indicates an accuracy of the machine learning model relative to an accuracy of a reference model. The reference model may include a machine learning model associated with known scores indicating an accuracy of the machine learning model. For example, the reference model may include a pre-trained machine learning model associated with a third-party entity (e.g., MobileNet, InceptionV3, ResNet50, and/or the like). In some implementations, the reference model is selected by the user (e.g., from a list of reference models displayed via the user interface). The interpretability data may provide explanations associated with a decision process of the machine learning model by reflecting the contributions of each feature. For example, the interpretability data may explain how the machine learning model predicts an image to be of a particular class.

In some implementations, the machine learning model comprises an image classifier model. The testing system may determine the score based on a quantity of test data samples, a quantity of test data samples correctly classified by the machine learning model, a total quantity of additional test cases generated based on different methods for testing generalization and robustness, a quantity of times covered from the test data samples (e.g., the total quantity of additional test cases generated based on different methods for testing generalization and robustness divided by the quantity of test data samples), a quantity of failure cases identified with the test data samples, a total quantity of failure cases identified from the additional test cases, and/or a quantity of time of failure identification (e.g., the total quantity of failure cases identified from the additional test cases divided by the quantity of failure cases identified with the test data samples).

In some implementations, the machine learning model comprises a word embedding model. In some implementations, the score indicates a quality of the word embedding model based on a synonym detection task. The testing system may utilize a dataset (e.g., a Test of English as a Foreign Language (TOEFL) dataset) that contains a quantity of question words. A question word may be associated with a quantity of choice words. The score may indicate an accuracy of the word embedding model to correctly identify a choice word, of the quantity of choice words associated with the question word, that is closest in meaning to the question word. For example, the score may indicate a percentage of the choice words that were correctly identified by the word embedding model.

In some implementations, the score indicates a quality of the word embedding model based on a word analogy task. The testing system may utilize an analogy dataset that contains a quantity of analogies associated with a plurality of conceptual categories (e.g., singular, plural, city-capital, opposite, and/or the like). The score may indicate an accuracy of the word embedding model to correctly identify a word “d” given the words “a”, “b”, and “c”, such that a relationship between the words “d” and “c” is similar to the relationship between the words “a” and “b”. For example, the score may indicate a percentage of analogies correctly predicted by the word embedding model.

In some implementations, the score indicates a quality of the word embedding model based on an outlier detection task. The testing system may utilize a dataset (e.g., an 8-8-8 dataset) that includes a quantity of words that are not included in common dictionaries. The word embedding model may receive a group of words as an input and may determine an outlier word included in the group of words. For example, a group of embedding vectors corresponding to the group of words may be provided to the word embedding model as an input. The word embedding model may determine an L2-distance between a word and a centroid (e.g., mean) of the rest of the words included in the group of words based on the embedding vectors. The word embedding model may identify the word having the maximum L2-distance as the outlier word. The score may indicate a percentage of outliers correctly detected by the word embedding model.

In some implementations, the score indicates a quality of the word embedding model based on a clustering task. The testing system may utilize a dataset (e.g., an Almuhareb and Poesio (AP) dataset) that includes a quantity of words associated with a plurality of categories. The testing system may randomly select a quantity (e.g., 2-5) of categories from the plurality of categories. The testing system may randomly select a quantity of words (e.g., 2-4) from each of the selected quantity of categories. The score may indicate a percentage of the selected words correctly clustered by the word embedding model.

As shown in FIG. 1F, and by reference number 130, the testing system performs one or more actions based on the score for the machine learning model. In some implementations, performing the one or more actions includes the testing system providing the score for display to a client device and receiving feedback on the score from the client device. The user may evaluate the score and may provide feedback associated with the score to the testing system. The feedback may include information indicating one or more additional test inputs to be used to evaluate the machine learning model, information associated with modifying the machine learning model, and/or the like.

In some implementations, performing the one or more actions includes the testing system generating and implementing additional test inputs for the machine learning model. For example, the testing system may generate the additional test inputs based on the information indicating the one or more additional test inputs included in the feedback. The testing system may evaluate the machine learning model based on the one or more additional test inputs.

In some implementations, performing the one or more actions includes the testing system providing a recommendation to modify the machine learning model based on the score. For example, the testing system may provide (e.g., to a developer of the machine learning model) a recommendation to modify the machine learning model based on the information associated with modifying the machine learning model included in the feedback.

In some implementations, performing the one or more actions includes the testing system identifying a performance issue with the machine learning model based on the score. For example, the testing system may identify an issue related to an accuracy of the machine learning model based on the score.

In some implementations, performing the one or more actions includes the testing system retraining the machine learning model based on the score. The testing system may determine that the score satisfies a score threshold. The testing system may retrain the machine learning model based on the score satisfying the score threshold. For example, the testing system may utilize feedback received from the user as additional training data for retraining the machine learning model, thereby increasing the quantity of training data available for training the machine learning model. Accordingly, the testing system may conserve-computing resources associated with identifying, obtaining, and/or generating data for training the machine learning model relative to other systems for identifying, obtaining, and/or generating data for training the machine learning model.

Further, increasing the amount of training data available for training the machine learning model based on the generalization testing methods, the robustness testing methods, and/or the interpretability methods may improve accuracy of the machine learning model in terms of generalization and robustness.

In this way, the testing system utilizes testing models to validate a machine learning model. The testing system interprets decisions of the machine learning model in a guided way to build trustworthiness in the machine learning model. The object oriented programming testing models test functionality of the machine learning model based on characteristics of the machine learning model, such as generalization, robustness, interpretability, and/or the like. This, in turn, conserves computing resources, networking resources, human resources, and/or the like that would otherwise have been wasted in implementing an untested machine learning model, identifying errors generated by the untested machine learning model, correcting the untested machine learning model to prevent the errors, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

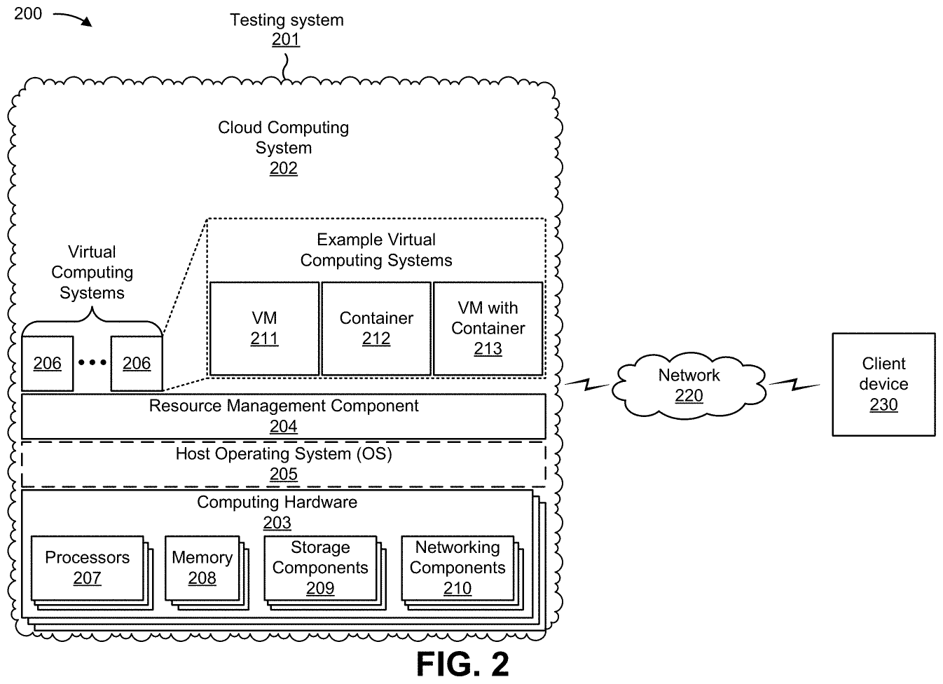

FIG. 2 is a diagram of an example environment 200 in which systems and/or methods described herein may be implemented. As shown in FIG. 2, environment 200 may include an testing system 201, which may include one or more elements of and/or may execute within a cloud computing system 202. The cloud computing system 202 may include one or more elements 203-213, as described in more detail below. As further shown in FIG. 2, environment 200 may include a network 220 and a client device 230. Devices and/or elements of environment 200 may interconnect via wired connections and/or wireless connections.

The cloud computing system 202 includes computing hardware 203, a resource management component 204, a host operating system (OS) 205, and/or one or more virtual computing systems 206. The resource management component 204 may perform virtualization (e.g., abstraction) of computing hardware 203 to create the one or more virtual computing systems 206. Using virtualization, the resource management component 204 enables a single computing device (e.g., a computer, a server, and/or the like) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

Computing hardware 203 includes hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, and/or the like) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using computing hardware 203. As shown, a virtual computing system 206 may include a virtual machine 211, a container 212, a hybrid environment 213 that includes a virtual machine and a container, and/or the like. A virtual computing system 206 may execute one or more applications using a file system that includes binary files, software libraries, and/or other resources required to execute applications on a guest operating system (e.g., within the virtual computing system 206) or the host operating system 205.

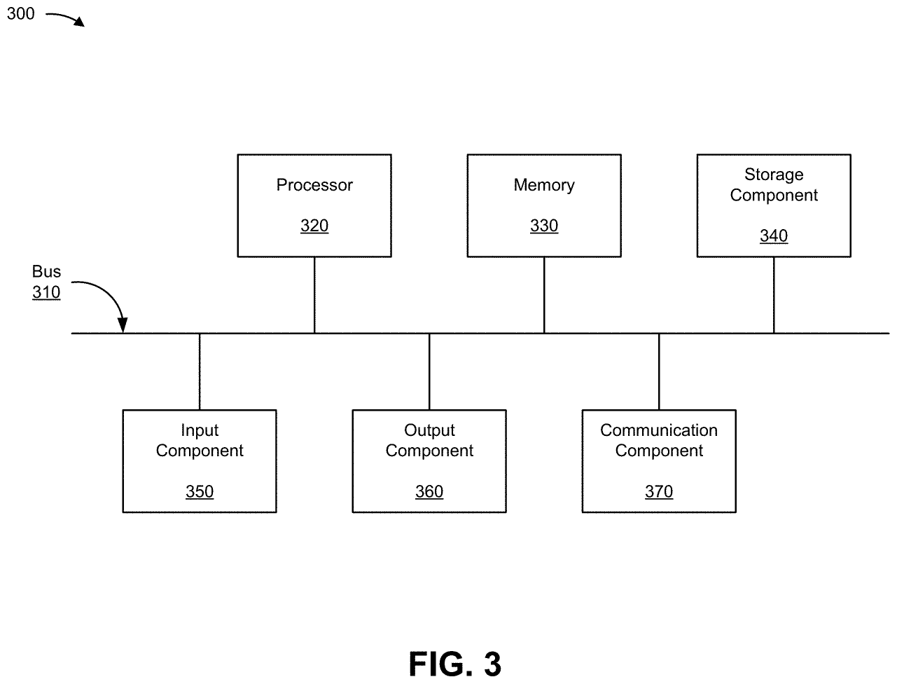

Although the testing system 201 may include one or more elements 203-213 of the cloud computing system 202, may execute within the cloud computing system 202, and/or may be hosted within the cloud computing system 202, in some implementations, the testing system 201 may not be cloud-based (e.g., may be implemented outside of a cloud computing system) or may be partially cloud-based. For example, the testing system 201 may include one or more devices that are not part of the cloud computing system 202, such as device 300 of FIG. 3, which may include a standalone server or another type of computing device. The testing system 201 may perform one or more operations and/or processes described in more detail elsewhere herein.

Network 220 includes one or more wired and/or wireless networks. For example, network 220 may include a cellular network, a public land mobile network (PLMN), a local area network (LAN), a wide area network (WAN), a private network, the Internet, and/or the like, and/or a combination of these or other types of networks. The network 220 enables communication among the devices of environment 200.

Client device 230 includes one or more devices capable of receiving, generating, storing, processing, and/or providing information, as described elsewhere herein. Client device 230 may include a communication device and/or a computing device. For example, client device 230 may include a wireless communication device, a user equipment (UE), a mobile phone (e.g., a smart phone or a cell phone, among other examples), a laptop computer, a tablet computer, a handheld computer, a desktop computer, a gaming device, a wearable communication device (e.g., a smart wristwatch or a pair of smart eyeglasses, among other examples), an Internet of Things (IoT) device, or a similar type of device. Client device 230 may communicate with one or more other devices of environment 200, as described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to testing system 201 and/or client device 230. In some implementations, testing system 201 and/or client device 230 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

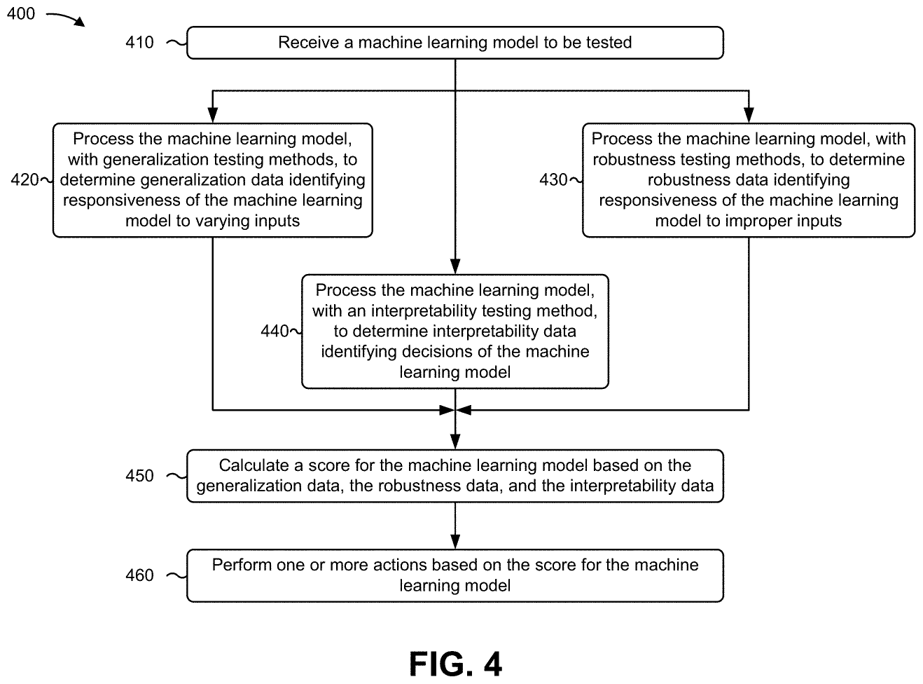

FIG. 4 is a flowchart of an example process 400 for utilizing object oriented programming testing models to validate a machine learning model. In some implementations, one or more process blocks of FIG. 4 may be performed by a device (e.g., testing system 201). In some implementations, one or more process blocks of FIG. 4 may be performed by another device or a group of devices separate from or including the device, such as a client device (e.g., client device 230). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving a machine learning model to be tested (block 410). For example, the device may receive a machine learning model to be tested, as described above. The machine learning model may include an image classifier model, a word embedding model, and/or any machine learning based classifier model.

As further shown in FIG. 4, process 400 may include processing the machine learning model, with generalization testing methods, to determine generalization data identifying responsiveness of the machine learning model to varying inputs (block 420). For example, the device may process the machine learning model, with generalization testing methods, to determine generalization data identifying responsiveness of the machine learning model to varying inputs, as described above. The generalization data may identify a performance ability of the machine learning model based on new inputs not used during training of the machine learning model.

In some implementations, when processing the machine learning model, with the generalization testing methods, to determine the generalization data, the device may determine rotation and translation data identifying an ability of the machine learning model to be invariant to rotations and translations of an image. The device may determine Fourier filtering data identifying an ability of the machine learning model to be invariant to information loss. The device may determine grey scale data identifying an ability of the machine learning model to be invariant to color content of the image. The device may determine contrast data identifying an ability of the machine learning model to be invariant to a contrast of the image. The device may determine additive noise data identifying an ability of the machine learning model to be invariant to noise in the image. The device may determine Eidolon noise data identifying an ability of the machine learning model to be invariant to noise that creates a form deformation. The device may determine model complexity data identifying a complexity of the machine learning model. The generalization data may include the rotation and translation data, the Fourier filtering data, the grey scale data, the contrast data, the additive noise data, Eidolon noise data, and/or the model complexity data.

As further shown in FIG. 4, process 400 may include processing the machine learning model, with robustness testing methods, to determine robustness data identifying responsiveness of the machine learning model to improper inputs (block 430). For example, the device may process the machine learning model, with robustness testing methods, to determine robustness data identifying responsiveness of the machine learning model to improper inputs, as described above. The robustness data may identify an ability of the machine learning model to not be susceptible to malicious inputs designed to fool the machine learning model.

In some implementations, when processing the machine learning model, with the robustness testing models, to determine the robustness data, the device may determine fast gradient sign method data identifying misclassifications of the machine learning model based on perturbations. The device may determine Carlini-Wagner method data identifying misclassifications of the machine learning model based on the perturbations. The device may determine adversarial patch data identifying an impact on the machine learning model by overlaying an adversarial patch on an image. The robustness data may include the fast gradient sign method data, the Carlini-Wagner method data, and the adversarial patch data.

In some implementations, when processing the machine learning model, with the robustness testing models, to determine the robustness data, the device may determine synonym detection data identifying correct identifications of synonyms by the machine learning model. The device may determine word analogy data identifying correct predictions of word analogies by the machine learning model. The device may determine outlier detection data identifying correct identifications of outlier words by the machine learning model. The device may determine clustering data identifying correct clustering of words by the machine learning model. The robustness data may include the synonym detection data, the word analogy data, the outlier detection data, and/or the clustering data.

As further shown in FIG. 4, process 400 may include processing the machine learning model, with an interpretability testing method, to determine interpretability data identifying decisions of the machine learning model (block 440). For example, the device may process the machine learning model, with an interpretability testing method, to determine interpretability data identifying decisions of the machine learning model, as described above. The interpretability testing method may include a local interpretable model-agnostic explanations model and/or a similar type of model that determines and explains decisions of the machine learning model. The interpretability data may identify incorrect features of an input that were used in decisions of the machine learning model.

As further shown in FIG. 4, process 400 may include calculating a score for the machine learning model based on the generalization data, the robustness data, and the interpretability data (block 450). For example, the device may calculate a score for the machine learning model based on the generalization data, the robustness data, and the interpretability data, as described above.

As further shown in FIG. 4, process 400 may include performing one or more actions based on the score for the machine learning model (block 460). For example, the device may perform one or more actions based on the score for the machine learning model, as described above.

In some implementations, performing the one or more actions may comprise providing the score for display to a client device, receiving feedback on the score from the client device, and modifying the machine learning model based on the feedback. Alternatively, and/or additionally, performing the one or more actions may comprise one or more of generating additional test inputs for the machine learning model based on the score and implementing the additional test inputs for testing the machine learning model, modifying the machine learning model based on the score, causing the machine learning model to be implemented in an environment based on the score, identifying a performance issue with the machine learning model based on the score, or retraining one or more of the generalization testing methods, the robustness testing methods, or the interpretability testing method based on the score.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device, a machine learning model to be tested;
processing, by the device, the machine learning model, with generalization testing methods, to determine generalization data identifying responsiveness of the machine learning model to varying inputs;
processing, by the device, the machine learning model, with robustness testing methods, to determine robustness data identifying responsiveness of the machine learning model to improper inputs;
processing, by the device, the machine learning model, with an interpretability testing method, to determine interpretability data identifying decisions of the machine learning model;
calculating, by the device, a score for the machine learning model based on the generalization data, the robustness data, and the interpretability data; and
performing, by the device, one or more actions based on the score for the machine learning model.

2. The method of claim 1, wherein processing the machine learning model, with the generalization testing methods, to determine the generalization data comprises:
determining rotation and translation data identifying an ability of the machine learning model to be invariant to rotations and translations of an image;
determining Fourier filtering data identifying an ability of the machine learning model to be invariant to information loss;
determining grey scale data identifying an ability of the machine learning model to be invariant to color content of the image;
determining contrast data identifying an ability of the machine learning model to be invariant to a contrast of the image;
determining additive noise data identifying an ability of the machine learning model to be invariant to noise in the image;
determining Eidolon noise data identifying an ability of the machine learning model to be invariant to noise that creates a form deformation; and
determining model complexity data identifying a complexity of the machine learning model,
wherein the generalization data includes the rotation and translation data, the Fourier filtering data, the grey scale data, the contrast data, the additive noise data, Eidolon noise data, and the model complexity data.

3. The method of claim 1, wherein processing the machine learning model, with the robustness testing methods, to determine the robustness data comprises:
determining fast gradient sign method data identifying misclassifications of the machine learning model based on perturbations;
determining Carlini-Wagner method data identifying misclassifications of the machine learning model based on the perturbations; and
determining adversarial patch data identifying an impact on the machine learning model by overlaying an adversarial patch on an image,
wherein the robustness data includes the fast gradient sign method data, the Carlini-Wagner method data, and the adversarial patch data.

4. The method of claim 1, wherein the machine learning model includes a machine learning based classifier model or a word embedding model.

5. The method of claim 1, wherein performing the one or more actions comprises:
providing the score for display to a client device;
receiving feedback on the score from the client device; and
modifying the machine learning model based on the feedback.

6. The method of claim 1, wherein performing the one or more actions comprises one or more of:
generating additional test inputs for the machine learning model based on the score and implementing the additional test inputs for testing the machine learning model;
modifying the machine learning model based on the score; or
causing the machine learning model to be implemented in an environment based on the score.

7. The method of claim 1, wherein performing the one or more actions comprises one or more of:
identifying a performance issue with the machine learning model based on the score;
or
retraining one or more of the generalization testing methods, the robustness testing methods, or the interpretability testing method based on the score.

8. A device, comprising:
one or more memories; and
one or more processors, communicatively coupled to the one or more memories, configured to:
access a machine learning model to be tested;
process the machine learning model, with generalization testing methods, to determine generalization data identifying responsiveness of the machine learning model to varying inputs;
process the machine learning model, with robustness testing methods, to determine robustness data identifying responsiveness of the machine learning model to improper inputs;
process the machine learning model, with an interpretability testing method, to determine interpretability data identifying decisions of the machine learning model;
calculate a score for the machine learning model based on the generalization data, the robustness data, and the interpretability data;
generate additional test inputs for the machine learning model based on the score; and
implement the additional test inputs for testing the machine learning model.

9. The device of claim 8, wherein the generalization data identifies a performance ability of the machine learning model based on new inputs not used during training of the machine learning model.

10. The device of claim 8, wherein the robustness data identifies an ability of the machine learning model to not be susceptible to malicious inputs designed to fool the machine learning model.

11. The device of claim 8, wherein the interpretability data identifies incorrect features of an input that were used in decisions of the machine learning model.

12. The device of claim 8, wherein the interpretability testing method includes a local interpretable model-agnostic explanations method that determines and explains decisions of the machine learning model.

13. The device of claim 8, wherein the one or more processors, when processing the machine learning model, with the robustness testing methods, to determine the robustness data, are configured to:
determine synonym detection data identifying correct identifications of synonyms by the machine learning model;
determine word analogy data identifying correct predictions of word analogies by the machine learning model;
determine outlier detection data identifying correct identifications of outlier words by the machine learning model; and
determine clustering data identifying correct clustering of words by the machine learning model,
wherein the robustness data includes the synonym detection data, the word analogy data, the outlier detection data, and the clustering data.

14. The device of claim 8, wherein the one or more processors are further configured to:
modify the machine learning model, based on the score, to generate a modified machine learning model; and
cause the modified machine learning model to be implemented in an environment.

15. A non-transitory computer-readable medium storing a set of instructions, the set of instructions comprising:
one or more instructions that, when executed by one or more processors of a device, cause the device to:
receive a machine learning model to be tested,
wherein the machine learning model includes a machine learning based classifier model;
process the machine learning model, with generalization testing methods, to determine generalization data identifying responsiveness of the machine learning model to varying inputs;
process the machine learning model, with robustness testing methods, to determine robustness data identifying responsiveness of the machine learning model to improper inputs;
process the machine learning model, with an interpretability testing method, to determine interpretability data identifying decisions of the machine learning model;
calculate a score for the machine learning model based on the generalization data, the robustness data, and the interpretability data; and
perform one or more actions based on the score for the machine learning model.

16. The non-transitory computer-readable medium of claim 15, wherein the one or more instructions, that cause the device to process the machine learning model, with the generalization testing methods, to determine the generalization data, cause the device to:
determine rotation and translation data identifying an ability of the machine learning model to be invariant to rotations and translations of an image;
determine Fourier filtering data identifying an ability of the machine learning model to be invariant to information loss;
determine grey scale data identifying an ability of the machine learning model to be invariant to color content of the image;
determine contrast data identifying an ability of the machine learning model to be invariant to a contrast of the image;
determine additive noise data identifying an ability of the machine learning model to be invariant to noise in the image;
determine Eidolon noise data identifying an ability of the machine learning model to be invariant to noise that creates a form deformation; and
determine model complexity data identifying a complexity of the machine learning model,
wherein the generalization data includes the rotation and translation data, the Fourier filtering data, the grey scale data, the contrast data, the additive noise data, Eidolon noise data, and the model complexity data.

17. The non-transitory computer-readable medium of claim 15, wherein the one or more instructions, that cause the device to process the machine learning model, with the robustness testing methods, to determine the robustness data, cause the device to:
determine fast gradient sign method data identifying misclassifications of the machine learning model based on perturbations;
determine Carlini-Wagner method data identifying misclassifications of the machine learning model based on the perturbations; and
determine adversarial patch data identifying an impact on the machine learning model by overlaying an adversarial patch on an image,
wherein the robustness data includes the fast gradient sign method data, the Carlini-Wagner method data, and the adversarial patch data.

18. The non-transitory computer-readable medium of claim 15, wherein the one or more instructions, that cause the device to perform the one or more actions, cause the device to one or more of:
generate additional test inputs for the machine learning model based on the score and implement the additional test inputs for testing the machine learning model;
modify the machine learning model based on the score;
cause the machine learning model to be implemented in an environment based on the score;
identify and correct a performance issue with the machine learning model based on the score; or
retrain one or more of the generalization testing methods, the robustness testing models, or the interpretability testing model based on the score.

19. The non-transitory computer-readable medium of claim 15, wherein:
the generalization data identifies a performance ability of the machine learning model based on new inputs not used during training of the machine learning model,
the robustness data identifies an ability of the machine learning model to not be susceptible to malicious inputs designed to fool the machine learning model, and
the interpretability data identifies incorrect features of an input that were used in decisions of the machine learning model.

20. The non-transitory computer-readable medium of claim 15, wherein the one or more instructions, that cause the device to process the machine learning model, with the robustness testing methods, to determine the robustness data, cause the device to:
determine synonym detection data identifying correct identifications of synonyms by the machine learning model;
determine word analogy data identifying correct predictions of word analogies by the machine learning model;
determine outlier detection data identifying correct identifications of outlier words by the machine learning model; and
determine clustering data identifying correct clustering of words by the machine learning model,
wherein the robustness data includes the synonym detection data, the word analogy data, the outlier detection data, and the clustering data.
